(19) United States
(12) Patent Application Publication
(10) Pub. No.: US 2026/0044988 A1
(43) Pub. Date: Feb. 12, 2026

(54) METHOD AND APPARATUS FOR IMPROVING SPATIAL CORRELATION OF PTYCHOGRAPHY DATA

(71) Applicant: Electronics and Telecommunications Research Institute, Daejeon (KR)

(72) Inventors: Kwan Jung OH, Daejeon (KR); Yong Jun LIM, Daejeon (KR)

(73) Assignee: Electronics and Telecommunications Research Institute, Daejeon (KR)

(21) Appl. No.: 19/292,158

(22) Filed: Aug. 6, 2025

(30) Foreign Application Priority Data
Aug. 6, 2024 (KR) 10-2024-0104927

(51) Int. Cl. G06T 9/00; G06T 3/4084; G06T 7/174

(52) U.S. Cl. CPC G06T 9/00; G06T 3/4084; G06T 7/174; G06T 2207/10056; G06T 2207/20016; G06T 2207/20056

(57) ABSTRACT

A method for compressing ptychography data according to a present disclosure, the method comprises: receiving at least two low-resolution images as input, wherein the at least two low-resolution images include a first image and a second image; encoding the first image; decoding the encoded first image; and encoding the second image based on the decoded first image, wherein the second image is encoded by referencing first overlapping region information extracted from the decoded first image and the second image.

### BACKGROUND OF THE INVENTION

### Field of the Invention

The present disclosure relates to a method and apparatus for improving spatial correlation of ptychography data. More specifically, the present disclosure relates to a method and apparatus for improving spatial correlation of ptychography data through ptychography data compression based on overlapping region information.

### Description of the Related Art

Ptychographic microscopy can refer to a technique that reconstructs both an image and phase beyond the optical limitations of the corresponding optical module by synthesizing at least two low-resolution images, which are acquired using at least two light sources irradiated from various angles, in the Fourier domain. A representative example of ptychographic microscopy is Fourier Ptychographic Microscopy (FTM). The performance of Fourier Ptychographic Microscopy can be determined by how effectively the Fourier domain is filled with information acquired from various angles. A large number of low-resolution images must be acquired, and the amount of data to be processed and stored increases accordingly. Therefore, technologies for efficiently compressing and processing large amounts of data are being researched and developed.

### SUMMARY OF THE INVENTION

It is a further object of the present disclosure to provide a method and apparatus for improving spatial correlation of Fourier ptychography data by compressing data with reference to overlapping region information.

It is a further object of the present disclosure to provide a method and apparatus for improving spatial correlation of Fourier ptychography data by preferentially compressing data with a small amount of information.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for compressing ptychography data, the method comprising: receiving at least two low-resolution images as input, wherein the at least two low-resolution images include a first image and a second image; encoding the first image; decoding the encoded first image; and encoding the second image based on the decoded first image, wherein the second image is encoded by referencing first overlapping region information extracted from the decoded first image and the second image.

In the method for compressing ptychography data according to the present disclosure, the first image and the second image are acquired from light sources located at adjacent positions.

In the method for compressing ptychography data according to the present disclosure, the first overlapping region information is extracted from a Fourier domain.

In the method for compressing ptychography data according to the present disclosure, the first overlapping region information extracted from the Fourier domain is inverse-transformed to a spatial domain and used as reference.

In the method for compressing ptychography data according to the present disclosure, the at least two low-resolution images further include a third image, and the method further comprises: decoding the encoded second image; and encoding the third image based on the decoded second image, wherein the third image is encoded by referencing second overlapping region information extracted from the first image, the second image, and the third image.

In the method for compressing ptychography data according to the present disclosure, the second overlapping region information is extracted from a Fourier domain, and the second overlapping region information extracted from the Fourier domain is inverse-transformed to a spatial domain and used as reference.

In the method for compressing ptychography data according to the present disclosure, the at least two low-resolution images are encoded in order of increasing amount of information included in each image.

In the method for compressing ptychography data according to the present disclosure, the at least two low-resolution images further include a third image, and the first image, the second image, and the third image are encoded in the order of the third image, the second image, and the first image, according to the increasing amount of information included in the images.

In the method for compressing ptychography data according to the present disclosure, the second image is encoded by referencing third overlapping region information extracted from the second image and the decoded third image after decoding the encoded third image, and the first image is encoded by referencing fourth overlapping region information extracted from the first image and the decoded second image after decoding the encoded second image.

In accordance with an aspect of the present disclosure, the above and other objects can be accomplished by the provision of an apparatus for compressing ptychography data, the apparatus comprising: one or more transceivers; one or more memories; and one or more processors, the one or more processors being configured to: receive at least two low-resolution images as input, wherein the at least two low-resolution images include a first image and a second image, encode the first image, decode the encoded first image, and encode the second image based on the decoded first image, wherein the second image is encoded by referencing first overlapping region information extracted from the decoded first image and the second image.

In accordance with an aspect of the present disclosure, the above and other objects can be accomplished by the provision of a method for reconstructing a high-resolution image based on compressed ptychography data, the method comprising: decoding a first image; decoding a second image; and reconstructing a high-resolution image by integrating the decoded first image and the decoded second image, wherein the second image is decoded by referencing first overlapping region information extracted from the first image and the second image.

In the method for reconstructing a high-resolution image based on compressed ptychography data according to the present disclosure, the first image and the second image are acquired from light sources located at adjacent positions.

In the method for reconstructing a high-resolution image based on compressed ptychography data according to the present disclosure, the first overlapping region information is extracted from a Fourier domain.

In the method for reconstructing a high-resolution image based on compressed ptychography data according to the present disclosure, the first overlapping region information extracted from the Fourier domain is inverse-transformed to a spatial domain and used as reference.

In the method for reconstructing a high-resolution image based on compressed ptychography data according to the present disclosure, further comprising decoding a third image, the third image is decoded by referencing second overlapping region information extracted from the first image, the second image, and the third image.

In the method for reconstructing a high-resolution image based on compressed ptychography data according to the present disclosure, the second overlapping region information is extracted from a Fourier domain, and the second overlapping region information extracted from the Fourier domain is inverse-transformed to a spatial domain and used as reference.

In the method for reconstructing a high-resolution image based on compressed ptychography data according to the present disclosure, the first image and the second image are decoded in order of increasing amount of information included in each image.

In the method for reconstructing a high-resolution image based on compressed ptychography data according to the present disclosure, further comprising decoding a third image, and the first image, the second image, and the third image are decoded in the order of the third image, the second image, and the first image, according to the increasing amount of information included in the images.

In the method for reconstructing a high-resolution image based on compressed ptychography data according to the present disclosure, the second image is decoded by referencing third overlapping region information extracted from the third image and the second image after decoding the third image, and the first image is decoded by referencing fourth overlapping region information extracted from the second image and the first image after decoding the second image.

In accordance with an aspect of the present disclosure, the above and other objects can be accomplished by the provision of an apparatus for reconstructing a high-resolution image based on compressed ptychography data, the apparatus comprising: one or more transceivers; one or more memories; and one or more processors, the one or more processors being configured to: decode a first image, decode a second image, and reconstruct a high-resolution image by integrating the decoded first image and the decoded second image, wherein the second image is decoded by referencing first overlapping region information extracted from the first image and the second image.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a process of reconstructing a high-resolution image through Fourier Ptychographic Microscopy according to one embodiment of the present disclosure.

FIG. 2 is a diagram showing the configuration of an LED array and its position in the Fourier domain based on the NA, according to one embodiment of the present disclosure.

FIG. 3 is a drawing illustrating an image acquired in a bright field region according to one embodiment of the present disclosure.

FIG. 4 is a diagram illustrating an image acquired in a dark field region according to one embodiment of the present disclosure.

FIG. 5 is a diagram illustrating an example of scanning a plurality of low-resolution images to compress the plurality of low-resolution images according to one embodiment of the present disclosure.

FIG. 6 is a flowchart of a method for improving spatial correlation of ptychography data through ptychography data compression according to one embodiment of the present disclosure.

FIG. 7 is a diagram illustrating a compression order of ptychography data according to one embodiment of the present disclosure.

FIG. 8 is a flowchart of a method for improving spatial correlation of ptychography data through ptychography data compression according to one embodiment of the present disclosure.

FIG. 9 is a diagram illustrating an example of iterative optimization and high-resolution image reconstruction based on overlapping region information according to the present disclosure.

FIG. 10 is a block diagram of an apparatus for improving spatial correlation of ptychography data through ptychography data compression according to one embodiment of the present disclosure.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this application are briefly explained as follows.

Ptychographic microscopy can refer to a technique that reconstructs both an image and phase beyond the optical limitations of the corresponding optical module by synthesizing at least two low-resolution images, which are acquired using at least two light sources irradiated from various angles, in the Fourier domain. A representative example of ptychographic microscopy is Fourier Ptychographic Microscopy (FTM). The performance of Fourier Ptychographic Microscopy can be determined by how effectively the Fourier domain is filled with information acquired from various angles.

The Fourier Transform (FT) can refer to the conversion of a signal in the spatial domain into a signal in the Fourier domain (or frequency domain). The Fourier domain can be considered a region that represents how many Fourier components are included in the signal. The Fourier components can contain both the amplitude and phase of the signal. The Fast Fourier Transform (FFT) can refer to a method that improves the computational efficiency of the Fourier Transform.

The amplitude can represent the magnitude of a waveform. It can be calculated from the intensity of light. The phase can indicate the relative position of a point within one cycle of the waveform. It can arise from changes in the optical path length of the sample as light passes through it.

Meanwhile, the compression of low-resolution images (or ptychography data) described in the present disclosure can be understood as the encoding of low-resolution images. Alternatively, it may also be understood as a broad concept including both the encoding and decoding of low-resolution images.

This is because one or more decoded low-resolution images may also be used as reference information for compressing other low-resolution images. Therefore, the decoding of already compressed low-resolution images can be understood as a processing step included in the compression process of multiple low-resolution images.

Meanwhile, multiple compressed low-resolution images can be used for the reconstruction of a high-resolution image, and the decoding of low-resolution images, as included in the compression process of low-resolution images, should be clearly distinguished from the concept of high-resolution image reconstruction.

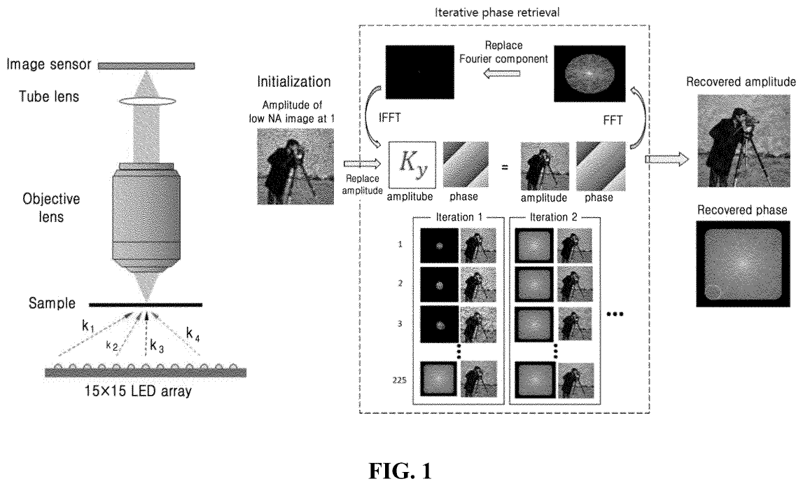

FIG. 1 is a diagram illustrating a process of reconstructing a high-resolution image through Fourier Ptychographic Microscopy according to one embodiment of the present disclosure.

Fourier ptychographic microscopy can be used to acquire at least two low-resolution images using light sources at different positions, which can then be combined to produce a high-resolution image.

Although the resolution of a single image in microscopy is limited by the optical constraints of the lens and wavelength used in the system, Fourier Ptychographic Microscopy can generate a high-resolution image that exceeds the optical limitations of the microscope by integrating multiple low-resolution images in the Fourier domain.

As illustrated in FIG. 1, a Fourier ptychographic microscope can include at least one of an LED array, an objective lens, a tube lens, and an image sensor.

The LED array can be arranged over the sample to illuminate it from different angles. Each LED in the array has a different angle of incidence, allowing the LED array to sample different regions in the Fourier domain of the sample. For example, the LED array can have a size of 15×15. Each LED in the array can be identified by an index. For example, each LED in a 15×15 LED array can be identified by an index from 1 to 225.

The objective lens can magnify the sample to form an intermediate image. The intermediate image may have a low resolution due to the characteristic of the objective lens having a low numerical aperture (NA). Here, NA can refer to the relative size of the lens.

The tube lens can either magnify or relay the intermediate image formed by the objective lens onto the image sensor.

The image sensor (e.g., a complementary metal-oxide-semiconductor (CMOS)) can convert light into digital signals to generate a digital image. The image sensor can record light that has passed through the objective lens and/or the tube lens and convert it into digital signals, thereby generating a low-resolution digital image.

Referring to FIG. 1, initialization can be performed for an iterative phase retrieval.

An initial value can be set for the iterative phase retrieval. The initial value can be any value or can be set using one of the low-resolution images.

For example, as illustrated in FIG. 1, the initial amplitude value can be set to the amplitude of a low-resolution image acquired from the light source at index 1.

Referring to FIG. 1, after setting the initial amplitude value, an estimated complex image can be generated. The estimated complex image can exist in the spatial domain. The complex image can include amplitude information and phase information. In this case, the estimated amplitude value of the complex image can be replaced with the measured amplitude value.

Referring to FIG. 1, a Fourier transform or a Fast Fourier transform can be performed on the replaced complex image. As the Fourier transform is performed, the amplitude and phase in the spatial domain can be represented as Fourier components in the Fourier domain. The Fourier components can include both amplitude and phase in the frequency domain.

Referring to FIG. 1, a plurality of low-resolution images can be integrated into a high-resolution image. More specifically, the Fourier components of the low-resolution images on which the Fourier transform has been performed can be integrated into the Fourier spectrum of the high-resolution image. The inverse Fourier transform (IFT) or the inverse fast Fourier transform (IFFT) can be performed on the integrated high-resolution Fourier spectrum. The high-resolution image acquired through the inverse Fourier transform can be the input for the next round of phase retrieval.

As illustrated in FIG. 1, the above-described iterative phase retrieval can be performed N times on the acquired low-resolution images. Here, N may be 1, 2, or any other positive integer. For example, the iterative phase retrieval as described above may be performed N times on the low-resolution images indexed from 1 to 225.

The final high-resolution image can be reconstructed by repeatedly generating a high-resolution Fourier spectrum through stitching and integrating Fourier components acquired from low-resolution images.

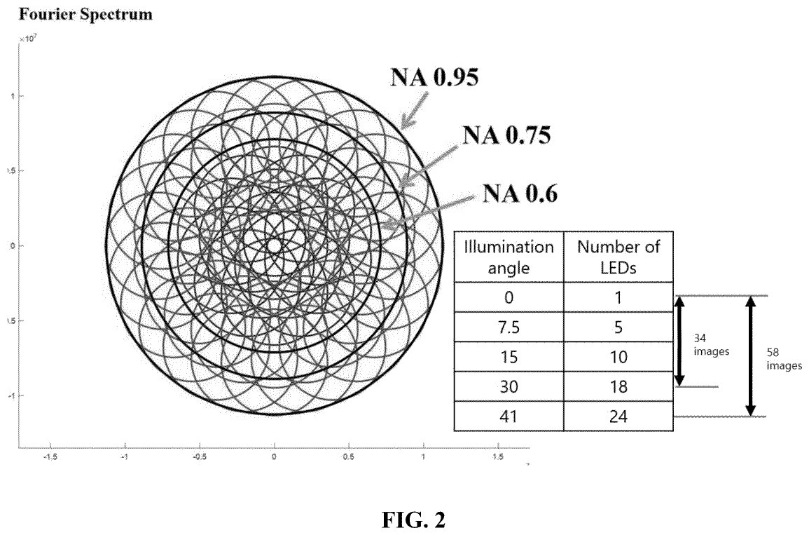

FIG. 2 is a diagram showing the configuration of an LED array and its position in the Fourier domain based on the NA, according to one embodiment of the present disclosure.

FIG. 2 shows an example of an LED array configuration for illuminating a sample. According to the table illustrated in FIG. 2, different numbers of LEDs can be used depending on the illumination angle (e.g., 0 degrees, 7.5 degrees, 15 degrees, 30 degrees, 41 degrees). By illuminating the sample from multiple angles using multiple LEDs, information from different regions in the Fourier domain can be acquired. For example, as illustrated in FIG. 2, a total of 58 low-resolution images, each containing information from a different region, can be acquired by using 58 LEDs.

In order to reconstruct a high-resolution image from low-resolution images, a method of stitching Fourier components acquired from low-resolution images can be used. In order to stitch information and integrate it into a high-resolution Fourier spectrum, an overlapping region in the Fourier domain may be required. A high-resolution image can be successfully reconstructed by integrating multiple low-resolution images through the overlapping region.

FIG. 2 shows the Fourier spectrum region captured by the objective lens when the NA of the objective lens is 0.6, 0.75, and 0.95, respectively. Referring to FIG. 2, it can be seen that as the NA increases, more information can be acquired in the Fourier domain. In general, FPM requires an overlapping region of more than 40% between low-resolution images acquired from adjacent illuminations.

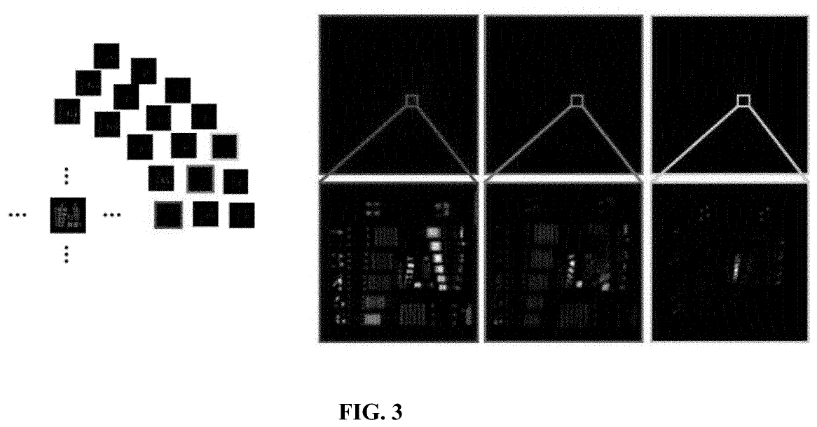

FIG. 3 is a drawing illustrating an image acquired in a bright field region according to one embodiment of the present disclosure.

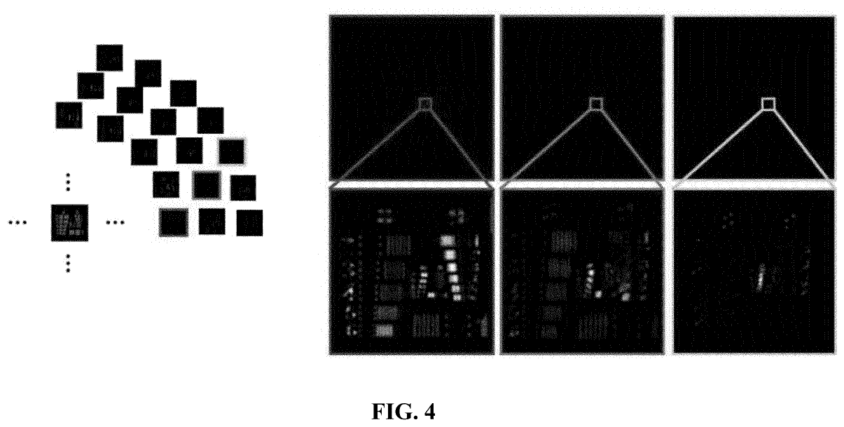

Also, FIG. 4 is a diagram illustrating an image acquired in a dark field region according to one embodiment of the present disclosure.

The information having relatively bright light in the center of the LED array and its surroundings can be called the bright field region. On the other hand, the region that is not the bright field region can be called the dark field region. In the frequency domain, the bright field region can contain information in a relatively low frequency region, and the dark field region can contain information in a relatively high frequency region.

Although there may be differences in precision, the bright field region is characterized by a relative high correlation between low-resolution images acquired from adjacent illuminations, as they contain similar information. In contrast, in the dark field region, only partial information remains as the illumination moves toward the periphery, resulting in a relatively low correlation between low-resolution images acquired from adjacent illuminations.

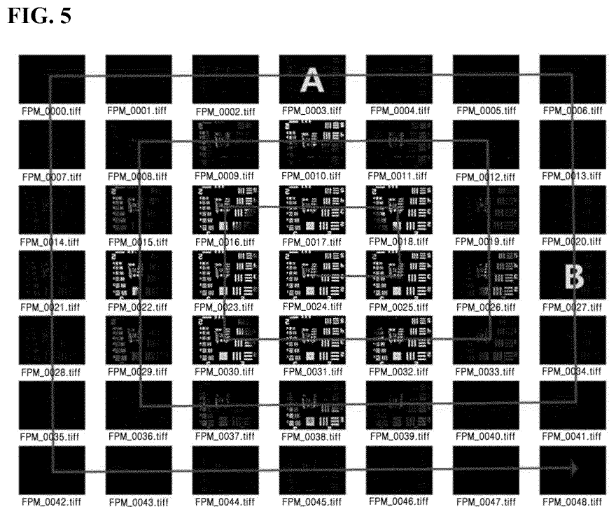

FIG. 5 is a diagram illustrating an example of scanning a plurality of low-resolution images to compress the plurality of low-resolution images according to one embodiment of the present disclosure.

In general, in order to compress multiple low-resolution images, methods such as connecting the images like a video stream or using multi-view image compression techniques can be used. These methods utilize the fact that there is a high correlation between consecutive images.

FIG. 5 illustrates an example of scanning in a spiral or radial manner from an image in a bright field region to an image in a dark field region. However, as examined with reference to FIG. 4, in cases where information is lost toward the periphery, the temporal correlation may decrease, which may deteriorate the compression efficiency of the image. Accordingly, in this disclosure, a method is proposed to improve the correlation of data by compressing Fourier ptychography data with reference to overlapping region information.

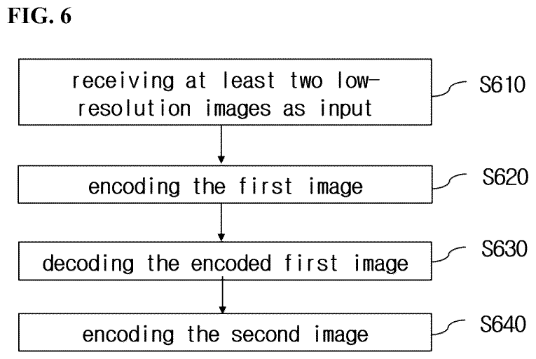

FIG. 6 is a flowchart of a method for improving spatial correlation of ptychography data through ptychography data compression according to one embodiment of the present disclosure.

Referring to FIG. 6, at least two low-resolution images are received as input (S610). There can be at least two low-resolution images, and can include a first image, a second image, a third image, etc.

At least two low-resolution images can be acquired from a Fourier ptychographic microscope. As described with reference to FIG. 1, the Fourier ptychographic microscope can include at least one of an LED array, an objective lens, a tube lens, and an image sensor.

Among the at least two low-resolution images, the first image and the second image may be low-resolution images acquired under adjacent illumination conditions.

Referring to FIG. 6, the first image can be encoded (S620), and the encoded first image can be decoded (S630).

The first image can be encoded and decoded by a method in a general image compression method. In this case, the encoding of the first image can be performed in the spatial domain.

Referring to FIG. 6, the second image can be encoded based on the decoded first image (S640).

In one embodiment of the present disclosure, a second image can be encoded with reference to a first image that has already been decoded. In this case, the encoding of the second image may be performed in the spatial domain by performing an inverse Fourier transform on the entire region of the first image and referring to the result.

However, when referring to the entire region of the decoded image, differences may occur due to non-overlapping regions, even though the decoded image and the image to be encoded are adjacent and similar in the spatial domain. Accordingly, the present disclosure proposes a method of compressing low-resolution images by referencing the overlapping region between the decoded image and the image to be encoded.

### Example 1

In another embodiment of the present disclosure, the second image can be encoded by referencing first overlapping region information extracted from the decoded first image and the second image.

Rather than referencing the entire region of the decoded image, it may be advantageous to reference only the overlapping region between the decoded image and the image to be encoded. That is, instead of referencing the entire region of the reference image, encoding can be performed by applying an inverse Fourier transform only to the overlapping region, and using the resulting image as a reference image in the spatial domain.

Meanwhile, a low-resolution image may appear to have relatively less information in the spatial domain, as it tends to contain only a limited range of frequency components under peripheral illumination. Accordingly, compression may be performed by considering the amount of information contained in the images, which varies depending on the position of the illumination. Hereinafter, the present disclosure proposes a method for compressing images in the order of increasing information amount by considering the amount of information contained in low-resolution images.

### Example 2

As examined with reference to FIG. 4, low-resolution images tend to contain only certain frequency components as the illumination moves toward the periphery, and thus may appear to have relatively less information in the spatial domain. Accordingly, it may be effective to start compressing from images with that contain relatively little information.

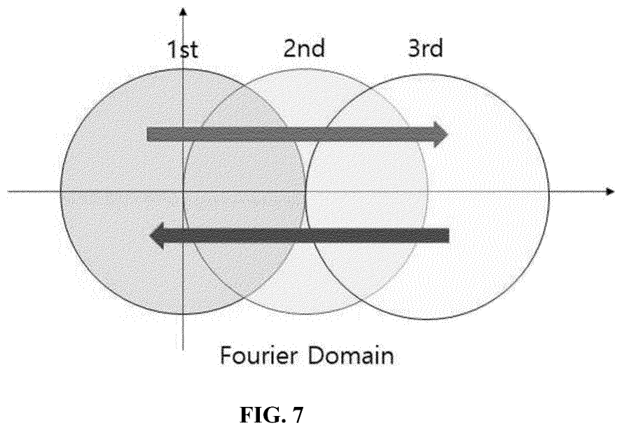

FIG. 7 is a diagram illustrating a compression order of ptychography data according to one embodiment of the present disclosure.

According to one embodiment of the present disclosure, a plurality of low-resolution images can be compressed in order of increasing amount of information contained in the images.

For example, as illustrated in FIG. 7, the first image, the second image, and the third image may be compressed in the order of the third image, the second image, and the first image, in order of the amount of information contained in the images. Here, the first image, the second image, and the third image may be low-resolution images acquired from adjacent illuminations. In addition, a larger image index may indicate that the image is located closer to the periphery.

If compression starts from the outer images, the amount of information tends to be very small, allowing for high compression efficiency. In addition, when encoding the image adjacent to the outer image, the previously encoded/decoded images almost contain the information of the image to be encoded, and since encoding is performed by referencing the previously encoded/decoded images, compression efficiency can be improved.

For example, the third image, which is an outer image, may be easy to compress because it has very little information. In this case, when compressing the second image, which is an image adjacent to the third image, the third image contains almost all of the information of the second image, so compression efficiency may be improved by using the third image as a reference image.

When compression starts from the outer images, the image of the bright-field region may be scanned spirally or radially for compression, starting from the image of the dark-field region, in the opposite direction to that examined in FIG. 5.

In addition, compression can be performed in order of increasing amount of information contained in the images, by extracting only the overlapping region between the decoded image and the image to be encoded, and using it as a reference image. In this case, the correlation between the images can be further improved, and the compression performance can be expected to be improved.

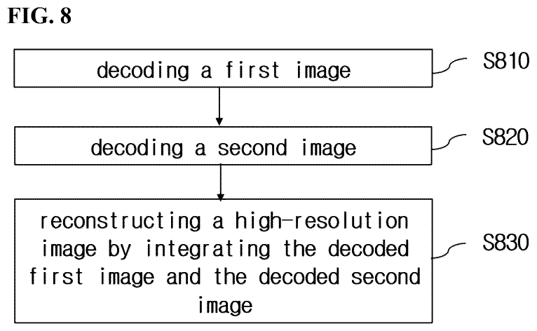

FIG. 8 is a flowchart of a method for improving spatial correlation of ptychography data through ptychography data compression according to one embodiment of the present disclosure.

Referring to FIG. 8, the first image can be decoded (S810), and the second image can be decoded (S820).

The low-resolution images can be decoded. The low-resolution images may include at least two or more images, and may include a first image, a second image, a third image, and so on.

In this case, at least two or more low-resolution images may be obtained from a Fourier ptychographic microscope. As described with reference to FIG. 1, the Fourier ptychographic microscope can include at least one of an LED array, an objective lens, a tube lens, and an image sensor.

Among the at least two low-resolution images, the first image and the second image may be low-resolution images acquired under adjacent illumination conditions.

The first image and the second image can be decoded by a method in a general image compression method.

In one embodiment of the present disclosure, a second image can be decoded by referencing a first image.

In another embodiment of the present disclosure, the second image can be encoded by referencing first overlapping region information extracted from the first image and the second image. This can be understood in the same manner as described with reference to FIG. 6, and thus, a detailed description thereof will be omitted to avoid redundancy.

Meanwhile, according to one embodiment of the present disclosure, a plurality of low-resolution images can be decoded in order of increasing amount of information contained in the images. This can be understood in the same manner as described with reference to FIGS. 6 and 7, and thus, a detailed description thereof will be omitted to avoid redundancy.

Referring to FIG. 8, a high-resolution image can be reconstructed by integrating the decoded first image and the decoded second image (S830).

The final high-resolution image can be reconstructed by repeatedly generating a high-resolution Fourier spectrum through stitching and integrating Fourier components acquired from low-resolution images.

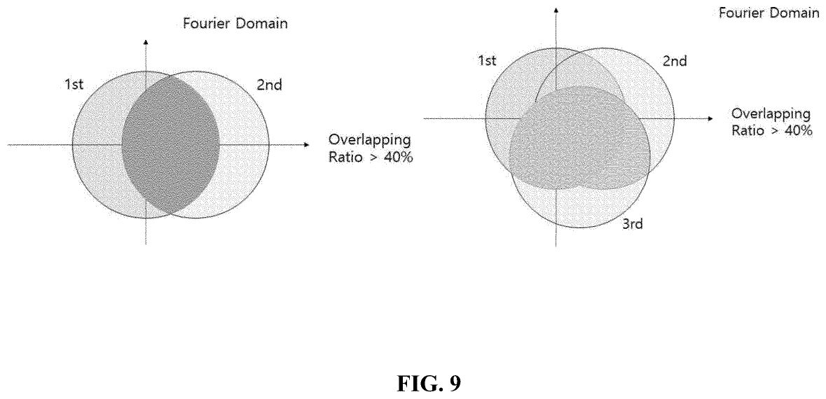

FIG. 9 is a diagram illustrating an example of iterative optimization and high-resolution image reconstruction based on overlapping region information according to the present disclosure.

On the left side of FIG. 9 two low-resolution images—the first image and the second image—acquired from adjacent illumination conditions using Fourier Ptychography Microscopy are illustrated. The first image and the second image are expressed in the Fourier domain. In this case, only the central blue region can be considered to be the overlapping region between the first image and the second image.

In this case, after the first image is encoded, the second image can be encoded by referencing the decoded version of the first image. In this case, the encoding of the second image can be performed in the spatial domain by performing an inverse Fourier transform on the entire region of the first image and using the result as a reference.

However, when referring to the entire region of the first image, differences may occur due to the non-overlapping region (yellow region) even though the first and second images are adjacent and similar in the spatial domain. Therefore, when encoding the second image, it may be advantageous to reference only the overlapping region (blue region) converted into the spatial domain, rather than referencing the entire region of the first image.

That is, rather than using the entire region of the image as a reference image, the first image and the second image are compared in the Fourier domain, and only the overlapping region can be used as a reference image in the spatial domain through inverse Fourier transform.

As described above, iterative phase retrieval can be performed at least once to reconstruct high-resolution images from low-resolution images. In this case, compression of low-resolution images can be performed by referencing overlapping region information extracted from at least two low-resolution images.

Specifically, compression for the second image can be performed by referencing overlapping region information extracted from the first image and the second image.

On the right side of FIG. 9 are illustrated three low-resolution images—the first image, the second image, and the third image—acquired under adjacent illumination conditions using Fourier Ptychography Microscopy.

The first image, the second image, and the third image are expressed in the Fourier domain. In this case, only the central green region can be considered to be the overlapping region between the first image, the second image, and the third image.

In this case as well, as in the previously discussed case, rather than using the entire regions of the decoded first and the decoded second image as reference images, it may be more effective to extract only the green region where the first image, the second image, and the third image overlap, perform inverse Fourier transform, and use the result as a reference image in the spatial domain.

In the iterative phase retrieval process, compression for the third image can be performed by referencing the overlapping region information extracted from the first image, the second image, and the third image.

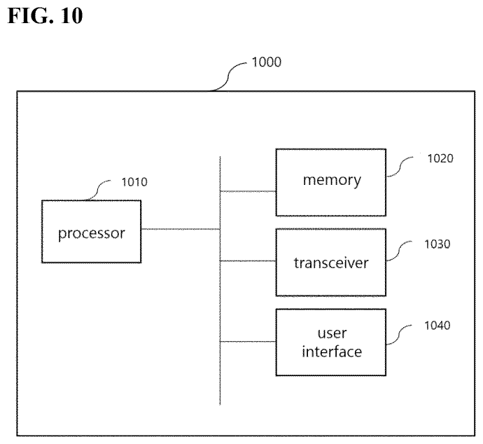

FIG. 10 is a block diagram of an apparatus for improving spatial correlation of ptychography data through ptychography data compression according to one embodiment of the present disclosure.

The apparatus (1000) may include one or more processors (1010), one or more memories (1020), one or more transceivers (1030), one or more user interfaces (1040), etc. The memory (1020) may be included in the processor (1010) or may be configured separately. The memory (1020) may store instructions that cause the apparatus (1000) to perform operations when executed by the processor (1010). The transceiver (1030) may transmit and/or receive signals, data, etc. that the apparatus (1000) exchanges with other entities. The user interface (1040) may receive an input of the user for the apparatus (1000) or provide an output of the apparatus (1000) to the user. Among the components of the apparatus (1000), components other than the processor (1010) and the memory (1020) may not be included in some cases, and other components not shown in FIG. 10 may be included in the apparatus (1000).

The processor (1010) may be configured to cause the apparatus (1000) to perform operations of the device according to various examples of the present disclosure. Although not illustrated in FIG. 10, the processor (1010) may be configured as a set of modules each performing a function. The modules may be configured in the form of hardware and/or software.

The processor (1010) of the apparatus (1000) can generally support/perform operations such as receiving at least two low-resolution images as input (wherein the at least two low-resolution images include a first image and a second image), encoding the first image, decoding the encoded first image, encoding the second image based on the decoded first image.

Here, the operation of encoding the second image based on the decoded first image may be set to include an operation of encoding the second image by referencing first overlapping region information extracted from the decoded first image and the second image.

Alternatively, the processor (1010) of the apparatus (1000) can generally support/perform operations such as decoding a first image, decoding a second image, and reconstructing a high-resolution image by integrating the decoded first image and the decoded second image.

Here, the operation of decoding the second image may be set to include an operation of decoding the second image by referencing first overlapping region information extracted from the first image and the second image.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for compressing ptychography data, comprising:
receiving at least two low-resolution images as input,
wherein the at least two low-resolution images include a first image and a second image;
encoding the first image; decoding the encoded first image; and
encoding the second image based on the decoded first image,
wherein the second image is encoded by referencing first overlapping region information extracted from the decoded first image and the second image.

2. The method of claim 1, wherein the first image and the second image are acquired from light sources located at adjacent positions.

3. The method of claim 1, wherein the first overlapping region information is extracted from a Fourier domain.

4. The method of claim 3, wherein the first overlapping region information extracted from the Fourier domain is inverse-transformed to a spatial domain and used as reference.

5. The method of claim 1, wherein the at least two low-resolution images further include a third image, and the method further comprises:
decoding the encoded second image; and
encoding the third image based on the decoded second image,
wherein the third image is encoded by referencing second overlapping region information extracted from the first image, the second image, and the third image.

6. The method of claim 5, wherein the second overlapping region information is extracted from a Fourier domain, and
wherein the second overlapping region information extracted from the Fourier domain is inverse-transformed to a spatial domain and used as reference.

7. The method of claim 1, wherein the at least two low-resolution images are encoded in order of increasing amount of information included in each image.

8. The method of claim 7, wherein the at least two low-resolution images further include a third image, and
wherein the first image, the second image, and the third image are encoded in the order of the third image, the second image, and the first image, according to the increasing amount of information included in the images.

9. The method of claim 8, wherein the second image is encoded by referencing third overlapping region information extracted from the second image and the decoded third image after decoding the encoded third image, and
wherein the first image is encoded by referencing fourth overlapping region information extracted from the first image and the decoded second image after decoding the encoded second image.

10. An apparatus for compressing ptychography data, comprising:
one or more transceivers;
one or more memories; and
one or more processors, the one or more processors being configured to:
receive at least two low-resolution images as input,
wherein the at least two low-resolution images include a first image and a second image,
encode the first image,
decode the encoded first image, and
encode the second image based on the decoded first image,
wherein the second image is encoded by referencing first overlapping region information extracted from the decoded first image and the second image.

11. A method for reconstructing a high-resolution image based on compressed ptychography data, comprising:
decoding a first image;
decoding a second image; and
reconstructing a high-resolution image by integrating the decoded first image and the decoded second image,
wherein the second image is decoded by referencing first overlapping region information extracted from the first image and the second image.

12. The method of claim 11, wherein the first image and the second image are acquired from light sources located at adjacent positions.

13. The method of claim 11, wherein the first overlapping region information is extracted from a Fourier domain.

14. The method of claim 13, wherein the first overlapping region information extracted from the Fourier domain is inverse-transformed to a spatial domain and used as reference.

15. The method of claim 11, further comprising:
decoding a third image,
wherein the third image is decoded by referencing second overlapping region information extracted from the first image, the second image, and the third image.

16. The method of claim 15, wherein the second overlapping region information is extracted from a Fourier domain, and
wherein the second overlapping region information extracted from the Fourier domain is inverse-transformed to a spatial domain and used as reference.

17. The method of claim 11, wherein the first image and the second image are decoded in order of increasing amount of information included in each image.

18. The method of claim 17, further comprising:
decoding a third image,
wherein the first image, the second image, and the third image are decoded in the order of the third image, the second image, and the first image, according to the increasing amount of information included in the images.

19. The method of claim 18, wherein the second image is decoded by referencing third overlapping region information extracted from the third image and the second image after decoding the third image, and
wherein the first image is decoded by referencing fourth overlapping region information extracted from the second image and the first image after decoding the second image.

20. An apparatus for reconstructing a high-resolution image based on compressed ptychography data, comprising:
one or more transceivers;
one or more memories; and
one or more processors, the one or more processors being configured to:
decode a first image,
decode a second image, and
reconstruct a high-resolution image by integrating the decoded first image and the decoded second image,
wherein the second image is decoded by referencing first overlapping region information extracted from the first image and the second image.
